(19) United States
(12) Patent Application Publication
(10) Pub. No.: US 2014/0222461 A1
(43) Pub. Date: Aug. 7, 2014

(54) Machines, Computer-Implemented Methods and Computer Media Having Computer Programs for Clinical Data Integration

(71) Applicant: South Texas Accelerated Research Therapeutics, LLC, (US)

(72) Inventors: Anthony William Tolcher, San Antonio, TX (US); Jamie Wayne Mills, San Antonio, TX (US); Ronald Eugene Lovell, Castroville, TX (US); Gina Louise Mangold, Castroville, TX (US); Theresa Mays Hutchings, San Antonio, TX (US); Leslie Ann Smetzer, San Antonio, TX (US); Cally Claude Claiborne, San Antonio, TX (US)

(21) Appl. No.: 13/787,220

(22) Filed: Mar. 6, 2013

Related U.S. Application Data
(60) Provisional application No. 61/760,260, filed on Feb. 4, 2013.

(51) Int. Cl. G06F 19/00

(52) U.S. Cl. CPC G06F 19/322
USPC 705/3

(57) ABSTRACT

Embodiments of a machine, computer-implemented method, and computer medium having computer program are provided to manage clinical data include components and operations for transmitting data between a site-side platform for the collection and management of electronic medical records (EMRs) relating to treatment of clinical patients and a sponsor-side platform for assessing and managing data relating to a clinical study.

### RELATED APPLICATIONS

This application is a non-provisional of and claims the benefit and priority to U.S. Provisional Patent Application No. 61/760,260 titled “Machines, Computer-Implemented Methods and Computer Media Having Computer Programs for Clinical Data Integration and Delivery” filed Feb. 4, 2013, which is incorporated herein by reference in its entirety.

### BACKGROUND

1. Field of the Invention

The invention relates generally to computer-implemented methods and systems or machines for managing clinical research data. More specifically, the invention relates to methods, machines or systems, and computer programs to transmit data between a site-side platform for the collection and management of electronic medical records (EMRs) relating to the treatment of clinical patients at one or more clinical study sites and one or more sponsor-side platforms.

2. Related Art

Currently, the vast majority of clinical research data generated for clinical research studies, e.g., studies performed on research subjects such as clinical patients receiving medical care for oncology is obtained at number of distinct clinical study sites, e.g., hospitals, laboratories, clinics or doctors' offices. The data generated includes objective data such as a clinical patient's vital signs or laboratory results, as well as subjective data such as general conditions or appearances of a clinical patient as documented in nursing notes. The data is initially captured in a number of diverse source documents including, e.g., paper clinical research records, electronic clinical research records, laboratory results (paper or digital), electrocardiograms and radiologic images. Data from the source documents may be hand entered by data managers into paper case report forms (CRFs) or key entered by data managers into electronic data capture (EDC) systems. The data is typically anonymized by the data managers at the clinical site to de-identify the clinical patient from the data for the protection of the research subjects' privacy. Once anonymized, the data corresponding to a particular clinical study is generally made available to the clinical sponsor, e.g. a drug company, the clinical sponsor's representative, e.g., a contract research organization (CRO) and/or a data monitor.

The data is monitored infrequently (customarily monthly), to verify the data entered from source documents as well as to correct transcription errors associated with hand or key entered data. The clinical sponsor can then review the verified data from the EDC system, make decisions regarding the safety of the investigational agent or treatment, and furthermore make decisions regarding dose escalation, continuation of the clinical study, or possible indications for future development. These multiple steps delay significantly the time between data collection at the clinical site and review and decision making by the study clinical sponsor, and contributes, in part, to the slow pace of clinical research in cancer medicine.

### SUMMARY OF THE INVENTION

Embodiments of machine, computer-implemented methods, and computer medium having computer program for performing a process of managing clinical research data by transmitting data between a site-side platform for managing patient records and a sponsor-side platform for managing clinical study records is described herein. An interface program according to embodiments of the invention permits pharmaceutical research clinical sponsors to provide an electronic case report form (eCRF) from a remote location and receive available data from the site-side platform in real-time. For instance, a clinical sponsor may be able to provide a newly designed eCRF for a particular clinical study, and after an initial design/testing phase for the interface (which may require up to three weeks), the clinical sponsor may be able to receive updated reports within minutes of requesting an update, or automatically within minutes of updated data becoming available at any one of the numerous clinical sites on the site-side platform.

An embodiment of a clinical data management machine for enhancing transfer between platforms of clinical research data collected in clinical research studies, for example, includes one or more site-side platforms for managing clinical patient data. The site-side platform includes an electronic medical records database storing data including one or more of clinical patient exam records documenting observational clinical data recorded by a plurality of health care providers examining a plurality of clinical patients, and clinical lab reports documenting data relating to one or more of a urine analysis, a blood analysis, toxicology information, and a chemical lab test of a clinical patient. The clinical data management machine also includes a sponsor-side platform for managing clinical study data. The sponsor-side platform includes one or more sponsor-side databases storing one or more eCRFs related to a predefined clinical study, and the eCRFs include a plurality of data fields and a plurality of field names identifying the appropriate data for inclusion in the plurality of data fields. The clinical data management machine also includes a clinical interface in communication with both of the site-side platform and the sponsor-side platform. The clinical interface includes a computer having a non-transitory computer memory with a computer code stored thereon, and the computer code is operable to (a) receive input from the sponsor side platform in the form of the eCRF, (b) retrieve data from the electronic medical records database corresponding to the field names included on the eCRF, (c) correlate the data from the electronic medical records database with the field names included on the eCRF, and (d) output the correlated data to the sponsor-side platform.

In other embodiments, a computer-implemented method includes the operations of (a) receiving an unpopulated eCRF related to a predefined clinical study, the eCRF including a plurality of data fields and a plurality of field names identifying the appropriate data for inclusion in the plurality of data fields, (b) defining data requirements of the predefined clinical study from the field names included on the eCRF, (c) querying an electronic medical records database to retrieve data corresponding to the field names included on the eCRF, (d) converting the data retrieved from the electronic medical records database to correspond to the field names provided on the eCRF, and (e) outputting the converted data.

In other embodiments, a computer program product implements the steps of the computer-implemented method described above. In some embodiments, the computer program product can be embodied on a computer readable medium.

### BRIEF DESCRIPTION OF THE DRAWINGS

So that the manner in which the features and advantages of the invention, as well as others, which will become apparent, may be understood in more detail, a more particular description of the invention briefly summarized above may be had by reference to the embodiments thereof, which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a prior art block diagram illustrating a site-side platform and a sponsor-side platform of a prior art clinical study data management system.

FIG. 2A is a system diagram symbolically illustrating aspects of a clinical study data management machine including a clinical interface between a site-side platform and a sponsor-side platform according to an embodiment of the invention.

FIG. 2B is an illustration of a graphical user interface associated with the sponsor-side platform of FIG. 2A according to an embodiment of the invention.

FIG. 3 is flow diagram of a computer-implemented process for a computer program stored on non-transitory, tangible computer medium of the clinical interface of FIG. 2A for transmitting data between the site-side platform and the sponsor-side platform according to an embodiment of the invention.

FIGS. 4A and B depict a flow diagram of an example implementation of a computer-implemented process according to an embodiment of the invention.

FIG. 5 is a flow diagram of an additional example, optionally upgraded, implementation of a computer-implemented process according to an embodiment of the invention.

### DETAILED DESCRIPTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art.

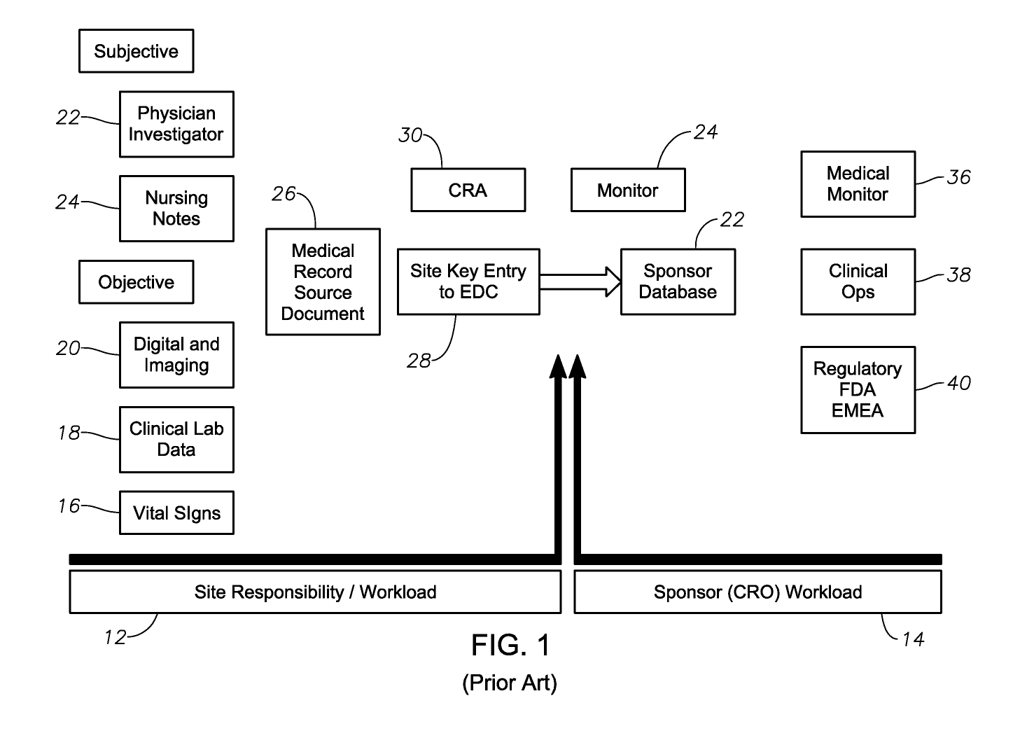

Currently, the systems for managing clinical research data are generally organized onto two distinct platforms as illustrated in FIG. 1. A clinical data management system 10 comprises a site-side platform 12 wherein clinical data from one or more, and possibly hundreds of clinical sites around the world is collected, and a sponsor side-platform 14 where the a clinical sponsor has access to the data for analysis, e.g., to ascertain the safety of effectiveness of an investigational agent or treatment, or to make decisions about the need to alter or continue the clinical study. On the site-side platform 12, both objective data including vital signs 16, clinical laboratory results 18 (complete blood counts (CBC), clinical chemistry, tumor markers, etc.) and digital and imaging data 20 (electrocardiographic data, QTC waveforms derived from digital twelve-lead electrocardiogram (EKG), and imaging data derived from archiving systems), as well as subjective data obtained by the physician investigator 22 or gleaned from nursing notes 24 taken at the bedside or clinic is documented in an appropriate medical record source document 26. From the medical record source documents 26, the data may be categorized, e.g., according to the National Cancer Institute common toxicity criteria is NCI-CTC, anonymized, and keyed into an EDC system 28 by a site-side clinical research associate (CRA) 30. The responsibility for data entry into the EDC system has generally been shifted to a CRA on the site-side platform 12 since clinical sponsors typically find the data within source documents 26 too fragmented to manage on the sponsor-side platform 14.

Once in the EDC system 28, the data may be transmitted through appropriate channels to a sponsor database 32 hosted by a sponsor-side clinical data management system such as the Oracle Clinical (O/C) system provided by Oracle Inc., Redwood Shores, Calif. or the Rave® system provided by Medidata Solutions of New York, N.Y. The data may be stored in the sponsor database 32 as organized according to the data requirements of the particular clinical study, e.g. in a plurality of electronic clinical report forms (eCRFs). A monitor 34 may verify the data from the sponsor database 32 by inspecting the data contained in the eCRFs to ensure it falls within appropriate ranges, to verify consistency with correlated data or by visually comparing the data to the medical record source documents 26. Clinical researchers such as a medical monitor 36 and clinical operations personnel 38 may also access the sponsor database 32. Medical monitors 36, for example, may access the sponsor database to identify trends in the data and propose any changes to the clinical study, and the clinical operations personnel 38, for example, may access the sponsor database 32 to identify inefficiencies in the execution of the clinical study. The data on the sponsor database 32 may also be made available to an appropriate regulatory body 40 such as the United States Federal Drug Administration (FDA) or the European Medicines Agency (EMEA). The regulatory body 40 may evaluate the data for safety or effectiveness of the investigational agent or treatment and, if the data meets the criteria set forth by the regulatory body, authorize continuation of the clinical study.

Embodiments of the invention provide a machine, computer medium having computer program stored therein, and computer-implemented method capable of facilitating the interface between one or more site-side platforms and one or more sponsor-side platform of a clinical data management system. Embodiments of the invention provide a machine, computer medium having computer program, and computer-implemented method capable of providing requested clinical study data in real-time so that the most current clinical data can be observed by the appropriate clinical users within minutes of requesting the data. Embodiments of a machine, program product and computer-implemented method permit changes to the data requirements of a particular clinical study as documented in an eCRF. As one skilled in the art will appreciate, though the term clinical is used throughout the specification, drawings and claims, the term clinical as referenced herein can refer to any phase or type of drug or treatment study including preclinical or clinical studies, studies in author review, etc.

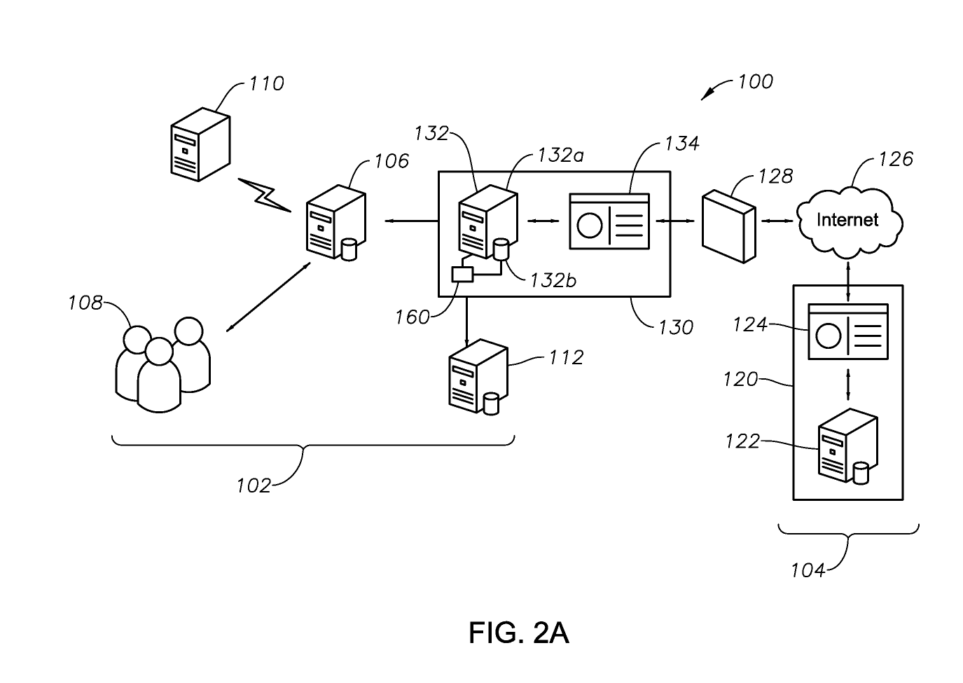

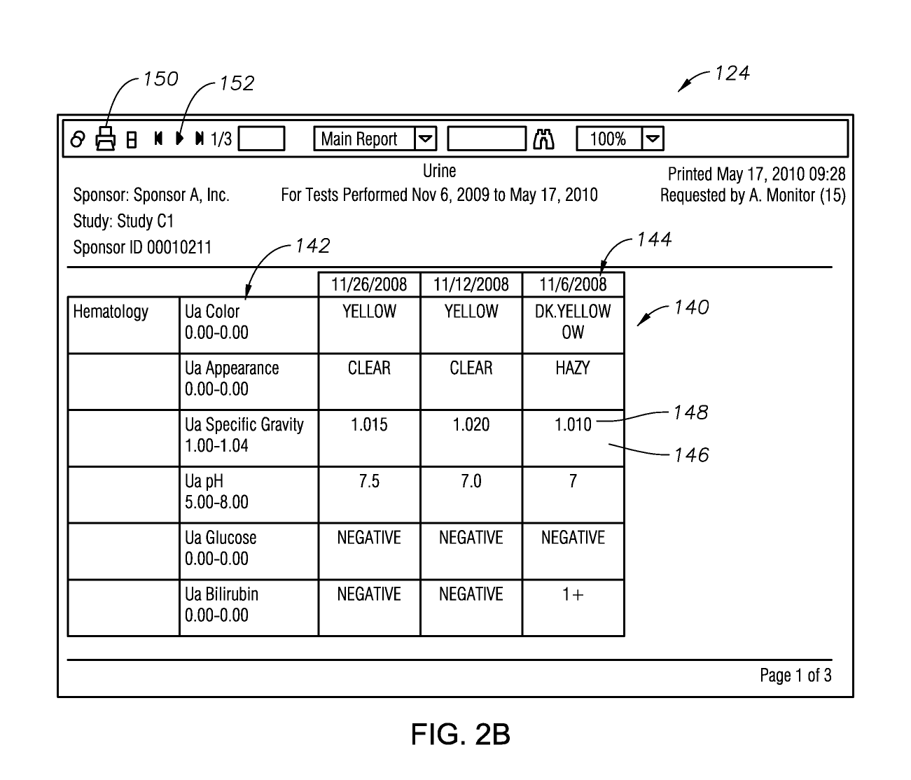

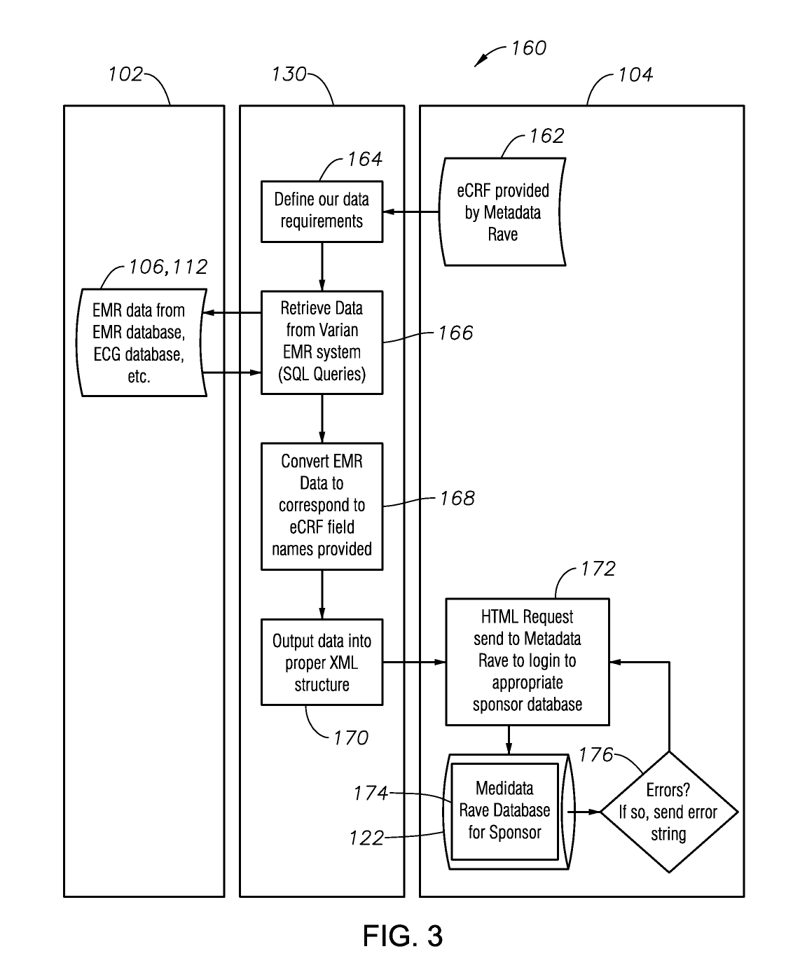

A system or machine, according to an embodiment of the invention, for managing a plurality of clinical research records for a plurality of clinical patients participating in drug studies is described herein with reference to FIG. 2A. A machine 100 is generally organized on a site-side platform 102 and a sponsor-side platform 104. On the site-side platform 102, the machine 100 comprises an electronic medical records database 106, which is configured for receiving input from a plurality of medical care providers 108, such as doctors and nurses from any number of clinical sites. The input provided by the medical care providers 108 includes objective data such as vital signs 16 (FIG. 1) and subjective data such as the impressions made by a doctor during physical investigation 22 and nursing notes 24. The electronic medical records database 106 is also configured to receive input from an internal and external lab database 110. The input provided by the internal and external lab database 110 includes clinical lab reports including such data as a urine analysis, a blood analysis, toxicology information, and/or chemical lab tests of a clinical patient. As one skilled in the art will appreciate, medical records database 106 may be connected to components such as a display [not shown] and keyboard that would allow, e.g., the medical care providers 108 direct access to the medical records database 106 such that the medical care providers 108 may input and access data to facilitate continued care of a clinical patient. The medical records database 106 may, e.g., be a component of a commercially available system such as the Aria® oncology information system available from Varian Medical Systems, Inc., Palo Alto, Calif., which permits medical care providers 108 to, e.g., monitor radiation dosages and review treatment images to evaluate the effectiveness of a treatment plan and determine if changes are necessary.

The electronic medical records database 106 may be connected to the internal and external lab database 110 through the internet or privately networked using a local area network (“LAN”), a wide area network (“WAN”), or combinations thereof. Privately networked components facilitate security, faster communication and better data synchronization, while connectivity through the internet may allow more global interaction between components. Any of the system components described herein may be connected by such configurations, and although not all such configurations are depicted in the drawings, all are within the scope of the disclosure.

An ECG database 112 is also maintained on the site-side platform 102 for storing electrocardiographic data. The ECG database 112 may be directly coupled to twelve-lead electrocardiogram systems [not shown] such that waveforms generated during electrocardiographic testing may be automatically stored therein. The ECG database 112 may also be coupled to an MRI, PET and/or a CT scan machine [not shown] such that any digital output from these machines may be stored in the ECG database 112.

On the sponsor-side platform 104, the machine 100 comprises a sponsor-side clinical data management system 120, which provides a sponsor-side database 122 and a user interface 124. The sponsor-side clinical data management system 120 is configured to permit sponsors or clinical research organizations to design, implement and review a particular clinical study, report data to regulatory bodies, or otherwise manage clinical data. The sponsor-side database 122 stores one or more eCRFs, which are comprised of a plurality of data fields associated with a corresponding plurality of data field names as described below. The eCRFs may be viewed and manipulated by the user interface 124 as described in greater detail below with reference to FIG. 2B.

The sponsor-side clinical data management system 120 is connected to the electronic medical records database 106 on the study-side platform 102 via a communications network 126, firewall 128 and a clinical interface 130. The clinical interface 130 includes a computer 132 and a user interface 134 of an embodiment of the present invention and is described in detail below. Communications network 126, which can be, e.g., a combination of the internet and intranet, allows a plurality sponsor-side clinical data management systems [not shown] to access the clinical research data generated and input on the site-side platform 102. Preferably, the communications network 126 works in conjunction with the firewall 128 to provide a secure access point for clinical users of the clinical data management system 120 and prevent non-authorized external clinical users from accessing the various databases on the site-side platform 102. The firewall 128 may be a network layer firewall, e.g., packet filters, application level firewalls, or proxy servers. As one skilled in the art will recognize, packet filters do not allow packets to pass through the firewall 128 unless they match an established rule set. In other words, a packet filter firewall 128 can be used to block traffic from particular source IP addresses, source ports, destination IP addresses or ports, or destination service like www or FTP, though a packet filter in this instance would most likely block certain source IP addresses. An application layer firewall 128 may intercept all packets traveling to or from the clinical interface 130 and may be used to prevent unauthorized clinical users from reaching protected machines. Finally, a proxy server may also act as firewall 128 by responding to some input packets and blocking other packets. While each of these firewalls can be used in the machine of the invention, preferably a CISCO hardware firewall is used.

The user interface 124 of the sponsor-side clinical data management system 120 will now be described with reference to FIG. 2B. The user interface 124 may be a graphical user interface (GUI) employed to display an exemplary eCRF 140 in the form of a urine record for a particular clinical patient. The urine record 140 is arranged as a table having data filed names 142 which may include, e.g., tests or measurements for a urinalysis (Ua) including Ua color, Ua appearance, Ua specific gravity, Ua pH, Ua Glucose, and Ua bilirubin. Other data field names 144 include test or measurement dates. The data field names 142, 144 identify the appropriate data for inclusion in a plurality of data fields 146, which are populated with the appropriate data 148.

As can also be seen, the user interface 124 may also include control icons such as a print icon 150, which may allow a clinical user to print the eCRF 140. In addition, scroll icons 152 are provided which may permit the clinical user to scroll though other pages provided by the user interface 124. As one skilled in the art will appreciate, the display page of FIG. 2B is merely an exemplary representation of the GUIs that may be provided for user interface 124. Other GUIs or interfaces may be created that will help design or change an eCRF or otherwise manage clinical study data, and accordingly not all embodiments of such GUIs have been described herein, but will be apparent to one of skill in the art. Accordingly, various GUIs may be used instead of or in addition to the display page described herein, and the display page is in no way to be considered limiting to the specification and claims, but is used in a descriptive sense only.

Referring again to FIG. 2A, the computer 132 of the clinical interface 130 includes a processor 132a and a memory 132b. Processor 132a is the “brains” of the clinical interface 130, and as such executes a computer program product 160 stored in the memory 132b. Processor 132a can be, e.g., any commercially available processor, or plurality of processors, including, e.g., Intel® Xeon® multicore processors, Intel® micro-architecture Nehalem, AMD Opteron™ multicore processors, etc. As one skilled in the art will appreciate, processor 132a may also include components that allow the computer 132 to be connected to user interface 134. Memory 132b is non-transitory computer memory with a computer code of the instant invention stored thereon. The memory 132b may consist of both non-volatile memory, e.g., hard disks, flash memory, optical disks, and the like, and volatile memory, e.g., SRAM, DRAM, SDRAM, etc., as required by embodiments of the instant invention. As one skilled in the art will appreciate, though memory 132b is depicted externally with respect to the processor 132a, the memory 132b and processor 132a may be packaged together within the computer 132.

The program product 160 of the instant invention comprises computer code stored in the memory 132b, and will be described with reference to FIG. 3. The program product 160 of clinical interface 130 accepts an unpopulated eCRF from the sponsor-side platform 104 (step 162). The eCRF may have been generated by a sponsor at any time prior to or during a particular clinical study to include the appropriate data fields corresponding to the particular clinical study and the appropriate data field names to identify the data fields. The computer program product 160 defines data requirements (step 164), e.g., by generating a list of the data required to populate the eCRF. When the data requirements are defined, the computer program product 160 retrieves data (step 166) from the site-side platform 102. The computer program 160 may execute commands such as structured query language (SQL) queries to select the appropriate data from an appropriate storage location. For example, if a particular data field of the eCRF requires an electrocardiographic waveform, an SQL query may be generated and executed against the ECG database 112 to select the appropriate waveform. Similarly, if a particular data field requires laboratory results, an SQL query may be executed to select the appropriate result from the electronic medical records database 106. The selected data may then be converted and organized (step 168) to correspond to the field names provided on the eCRF. The converted and organized data formatted into a structure appropriate for receipt into the sponsor-side database 122 (FIG. 2A) and output (step 170) from the clinical interface 130. Appropriate output structures may include, e.g., XML, CSV and/or SAS formats.

Once the data is output from the clinical interface 130, a request is sent (step 172) to log into the appropriate sponsor-side database 122. The communications network 126 and the firewall 128 (FIG. 2A) may be employed to establish communication with the sponsor-side database 122, and may require a password or appropriate permissions before data may be released to the sponsor-side database 122. The formatted data may then be received into the sponsor-side database 122 (step 174) where it may be acted upon by software modules of the sponsor or sponsor's representative. For example, a validation step (step 176) may be performed on the data to check for errors, e.g., by ensuring the data is complete and falls into appropriate ranges, by visually inspecting the appropriate source documents, etc., and sending an error string to the sponsor-side database 122 if errors are detected. As one skilled in the art will appreciate, other operations [not shown] may be performed on the study data received in the sponsor-side database from the clinical interface 130 such as populating the eCRF, displaying or reporting the study data, etc.

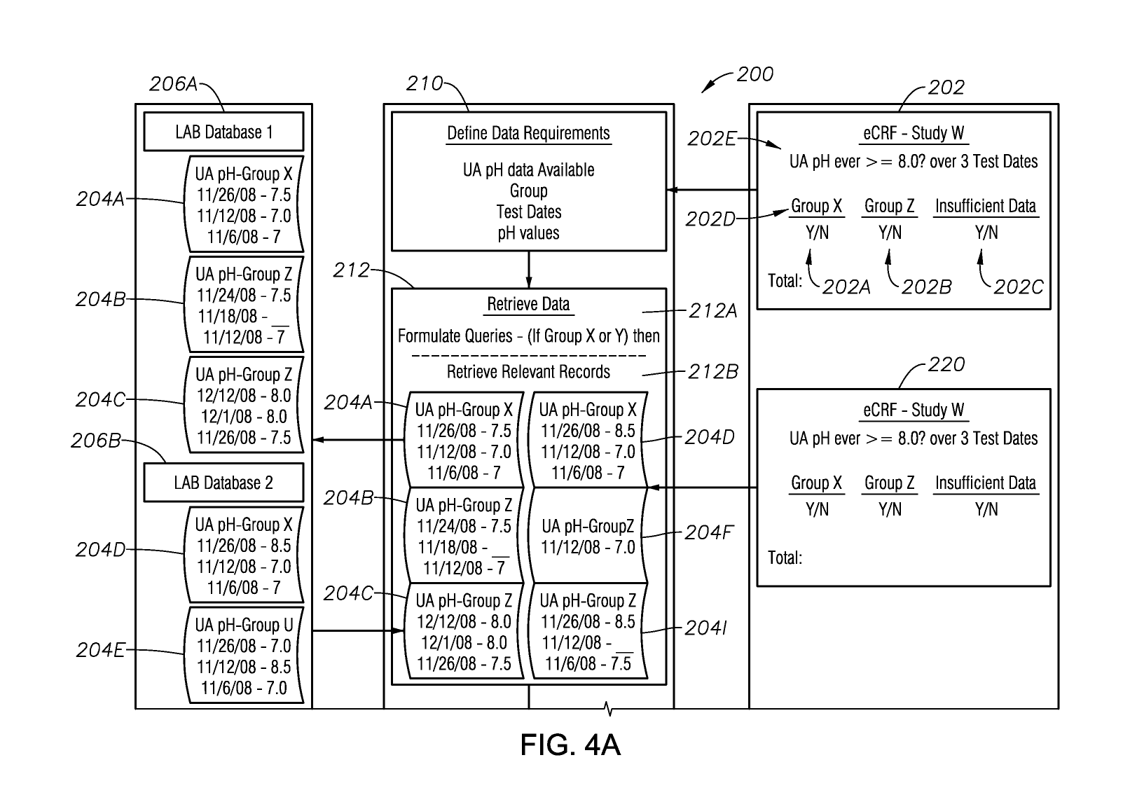

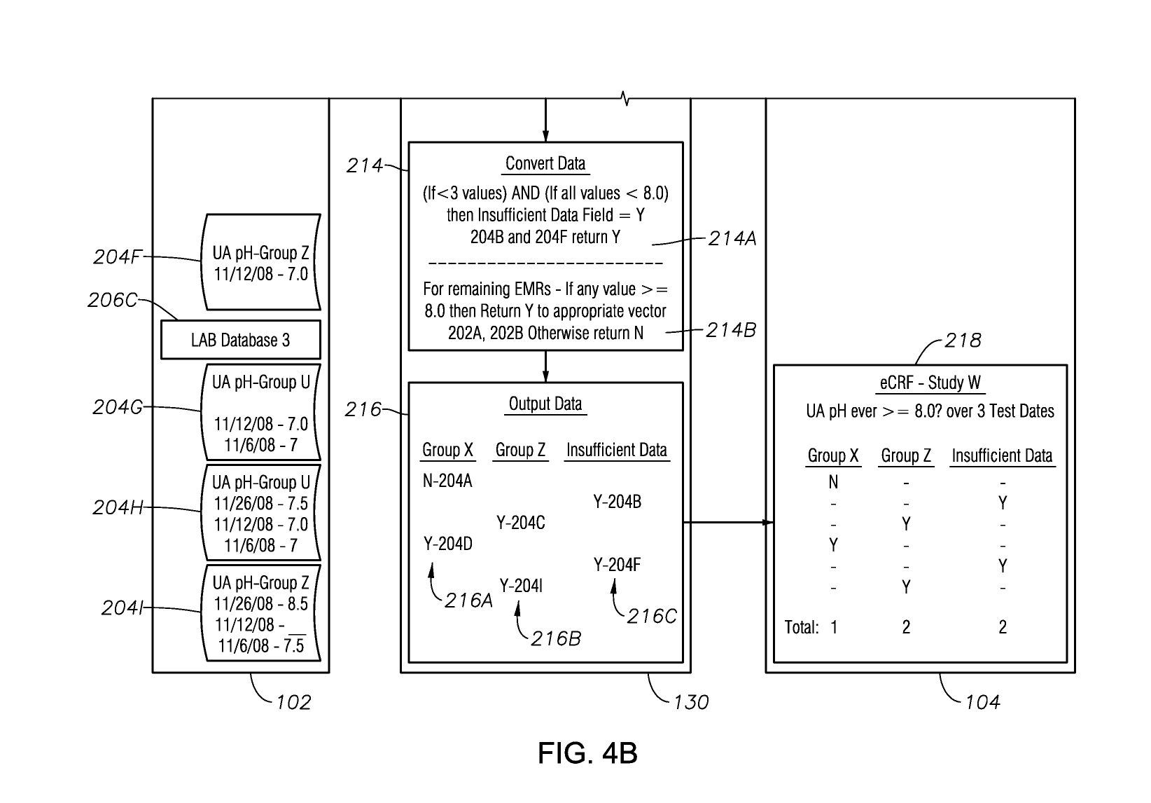

One example implementation of a computer-implemented process 200 of the instant invention will be described with reference to FIGS. 4A and 4B (collectively referred to as FIG. 4). The process 200 begins as a clinical sponsor on the sponsor-side platform 104 provides a layout of an eCRF (step 202). The example eCRF layout depicted includes three-column vector, data fields 202A, 202B, 202C, which may be populated by evaluating the data stored on the site-side platform 102. The data to be included in the vector data fields 202A, 202B, and 202C is identified by field names 202D. A condition 202E provides guidance on how the data stored on the site-side platform 102 may be converted to populate properly the vector data fields 202A, 202B, 202C. In this example, the vector data fields 202A, 202B, 202C require yes or no (Y/N) data points to be extracted from each appropriate one of a plurality of EMRs (204A through 2041) stored on the site-side platform 102 for two patient groups X and Z as described below.

Upon receipt of the eCRF, the data requirements are defined (step 210). An interface design technician may review the eCRF and determine which data fields on the site-side EMRs will need to be extracted. In the embodiment depicted, for the EMRs with UA pH data available, the group name, test dates and pH values will be extracted to determine whether the particular EMR should be associated with a yes or no (Y/N) value, and in which vector data field 202A, 202B or 202C. In some alternate embodiments, a computer program may be employed to define the data requirements. For example, where field names of a particular eCRF [not shown] sufficiently match the field names of data stored on the site-side platform 102, a computer program may be employed to generate a list of the data fields that are needed from the site-side platform 104.

Once the data requirements are defined, the appropriate data may be retrieved (step 212) from the site-side platform 102. The retrieve data step 212 may be divided into two sub-steps including sub-step 212A and sub-step 212B. The first sub-step 212A includes formulating queries that will allow only the necessary data to be retrieved. In the instant example, only EMRs relating to patient groups X and Z are relevant to the study W for which the eCRF has been provided in step 202. Thus, the interface design technician may formulate a query in SQL, and store the query as code instructions that induce the processor 132a (FIG. 2A) to retrieve an EMR if the EMR is related to either patient group X or Z. In the instant case, running the query executes sub-step 212B in which EMRs 204A, 204B, 204C, 204D, 204F, and 2041 are retrieved from the various databases 206A, 206B, and 206C disposed on the site side platform 102. The EMRs 204A, 204B, 204C, 204D, 204F, and 2041 may be temporarily stored on in the memory 132b of the computer 132 (FIG. 2A) disposed on the clinical interface 130.

The data contained in the temporarily stored EMRs 204A, 204B, 204C, 204D, 204F, and 2041 may then be converted (step 214) to correspond to the field names provided in the eCRF in step 202. In an initial sub-step 214A, the temporarily stored EMRs 204A, 204B, 204C, 204D, 204F and 2041 may be evaluated for containing sufficient information to properly ascertain the condition 202E. An insufficient data determination may be made for EMRs 204B and 204F, which do not contain three values, or any value greater than or equal to 8.0. Thus, Y values may be returned to an appropriate data structure for populating vector data field 202C. Although EMR 2041 contains only two values, condition 202E may be ascertained in sub-step 214B since one of the available values is greater than 8.0. Whether or not any subsequently acquired value for EMR 2041 is greater than or equal to 8.0, a Y value should be returned to an appropriate data structure for populating the vector data field 202B, which corresponds to patient group Z.

The data converted in step 214 may be output into a proper XML structure in step 216. The XML structure may include the converted data organized into three column vectors 216A, 216B and 216C that correspond to the column vectors 202A, 202B and 202C, respectively.

The converted data may be then be received (step 218) back on the sponsor side platform 104 where the eCRF may be populated and reviewed by clinical sponsors. The total number of data points collected may help a clinical sponsor ascertain how clinical study W is progressing, and how much more data might still need to be collected.

After an initial design and testing phase for clinical interface 130, a clinical sponsor may again provide the eCRF (step 220) to the clinical interface 130. Some time may have passed to permit additional clinical testing to further populate EMRs 204B and 204F, e.g., or additional EMRs [not shown] may have been added to the various databases 206A, 206B and 206C. Since the data requirements have previously been ascertained in step 210, and the appropriate queries have been formulated in sub-step 212A in the design and testing phase, the procedure may resume directly at sub-step 212B. Sub-step 212B and steps 214, 216 and 218 may be entirely computer implemented, so once an eCRF is provided in step 220, real-time data including all current updates may be returned to populate the eCRF in step 218. As one skilled in the art will recognize, the eCRF may be automatically provided intermittently or continually in step 220, e.g., every hour or every day at the discretion of a clinical sponsor. Providing the eCRF may automatically initiate sub-step 212B and steps 214, 216 and 218 such that any changes made on the site-side platform 102 automatically may be reflected on the eCRF on the sponsor side platform 104 at useful time intervals.

In certain embodiments, steps 210 and 212 may also be entirely computer-implemented. This might allow a clinical sponsor to provide an updated an eCRF in step 202 and receive a populated eCRF within minutes or seconds. For example, after some evaluation, the requirements of study W may change and a clinical sponsor may wish to know the number of any UA pH values greater than or equal to 8.5 (rather than 8.0). The processor 132a of the computer 132 (FIG. 2A) of the clinical interface 130 may be configured to recognize that sufficient design and testing had been performed, and that the process 200 may be implemented successfully with a revised condition 202E.

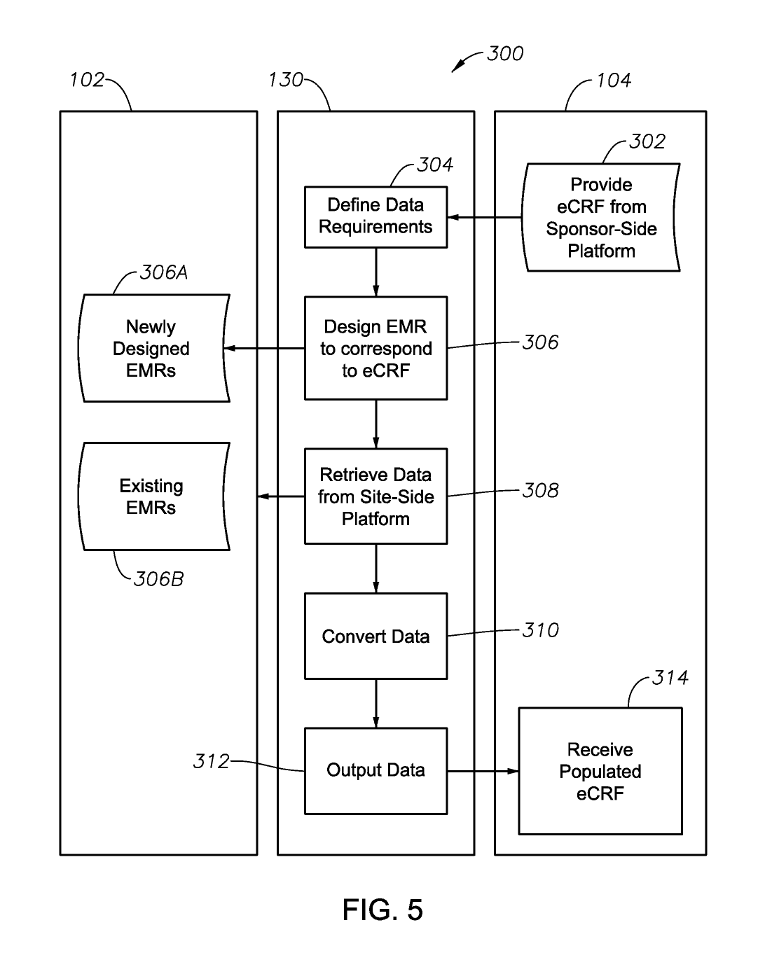

Referring now to FIG. 5, an upgraded process 300 is described. Initially, an eCRF may be provided from the sponsor-side platform 104 (step 302). The data requirements may then be defined (step 304) in a manner similar to step 210 of process 200 described above with reference to FIG. 4. An optional step 306 may be performed by an interface design technician for whom a custom EMR 306A is designed to accommodate the particular requirements of the eCRF provided in step 302. In some instances, existing EMRs 306B may not contain all the information necessary to populate properly an eCRF. Thus, EMRs 306A may be designed and provided to capture previously unavailable data. In other instances, a newly designed EMR 306A may be provided to the site-side platform 102 to eliminate the need for entry of redundant or unnecessary data. Once the newly designed EMRs 306A are in use, data may be retrieved from the site-side platform 102 (step 308). Appropriate queries may need to be formulated to ensure data is properly extracted from both the newly designed EMRs 306A and the existing EMRs 306B. The data may then be converted (step 310), output (step 312) and received (step 314) in a manner similar to steps 214, 216 and 218 of process 200 described above with reference to FIG. 4.

This application is a non-provisional of and claims the benefit and priority to U.S. Provisional Patent Application No. 61/760,260 titled “Machines, Computer-Implemented Methods and Computer Media Having Computer Programs for Clinical Data Integration and Delivery” filed Feb. 4, 2013, which is incorporated herein by reference in its entirety.

In the drawings and specification, there have been disclosed embodiments of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification, and such modifications and changes are to be considered equivalents and part of this disclosure.

What is claimed is:

1. A clinical data management machine for enhancing transfer between platforms of clinical research data collected in clinical research, the machine comprising:
one or more site-side platforms to manage clinical patient data, the site-side platform including an electronic medical records database storing data including one or more of clinical patient exam records and clinical lab reports, the clinical patient exam records including observational clinical data recorded by a plurality of health care providers examining a plurality of clinical patients, and the clinical lab reports including data relating to one or more of a urine analysis, a blood analysis, toxicology information, and a chemical lab test of a clinical patient;
one or more sponsor-side platforms to manage clinical study data, the sponsor-side platform including one or more sponsor-side databases storing one or more electronic case report forms (eCRFs) related to a predefined clinical study, the eCRFs including a plurality of data fields and a plurality of field names identifying the appropriate data for inclusion in the plurality of data fields; and
a clinical interface in communication with both of the one or more site-side platforms and the one or more sponsor side-platforms, the clinical interface including one or more processors and non-transitory computer memory having computer program stored thereon and executable by the one or more processors, the computer program being operable to:
receive input from the one or more sponsor side platforms in the form of the eCRF, retrieve data from the electronic medical records database corresponding to the field names included on the eCRF;
correlate the data from the electronic medical records database with the field names included on the eCRF; and
output the correlated data to the sponsor-side platform.

2. A clinical data management machine as defined in claim 1, wherein the computer code is operable to generate an SQL query and to execute the SQL query against the electronic medical records database to retrieve data from the electronic medical records database.

3. A clinical data management machine as defined in claim 1, wherein the computer code is further operable to identify a storage location for data on the site-side platform corresponding to the field names included on the eCRF.

4. A clinical data management machine as defined in claim 3, wherein the site side platform further includes an ECG database, and wherein the storage location is one of the electronic medical records database and the ECG database.

5. A clinical data management machine as defined in claim 1, wherein clinical interface is in communication with the through the internet and a firewall.

6. A clinical data management machine as defined in claim 1, wherein the computer code is further operable to define data requirements of the predefined clinical study from the field names included on the eCRF.

7. A computer-implemented method comprising:
receiving an unpopulated eCRF related to a predefined clinical study, the eCRF including a plurality of data fields and a plurality of field names identifying the appropriate data for inclusion in the plurality of data fields;
defining data requirements of the predefined clinical study from the field names included on the eCRF;
querying an electronic medical records database to retrieve data corresponding to the field names included on the eCRF;
converting the data retrieved from the electronic medical records database to correspond to the field names provided on the eCRF; and
outputting the converted data.

8. A computer-implemented method as defined in claim 7, wherein the operation of defining data requirements is performed by an interface design technician during a design and testing phase of the method.

9. A computer-implemented method as defined in claim 8, wherein an additional operation of formulating appropriate queries is performed by the interface design technician during the design and testing phase of the method.

10. A computer-implemented method as defined in claim 7, wherein the step of receiving an unpopulated eCRF is performed continually to automatically initiate the steps of querying an electronic medical records database, converting the data, and outputting the converted data such that the unpopulated eCRF may be populated automatically on a regular basis.

11. A computer-implemented method as defined in claim 7, further comprising the step of designing an EMR, wherein the step of designing the EMR is performed by the interface design technician during the design and testing phase of the method.

12. A computer-implemented method as defined in claim 11, wherein the step of designing an EMR includes designing an EMR to capture data unavailable data.

13. Non-transitory, tangible computer medium have computer program stored thereon and executable by one or more processors to perform the operations of:
receiving an unpopulated eCRF related to a predefined clinical study, the eCRF including a plurality of data fields and a plurality of field names identifying the appropriate data for inclusion in the plurality of data fields;
determining data requirements of the predefined clinical study from the field names included on the eCRF;
querying an electronic medical records database to retrieve data corresponding to the field names included on the eCRF;
converting the data retrieved from the electronic medical records database to correspond to the field names provided on the eCRF; and
outputting the converted data to populate the eCRF.

14. Non-transitory, tangible computer readable medium as defined in claim 13, wherein the computer program further includes the operations of defining data requirements to be performed by an interface design technician during design and test phase.

15. Non-transitory, tangible computer readable medium as defined in claim 14, wherein an additional operation of formulating appropriate queries is performed by the interface design technician during the design and testing phase of the method.

16. Non-transitory, tangible computer readable medium as defined in claim 13, wherein the step of receiving an unpopulated eCRF is performed continually to automatically initiate the steps of querying an electronic medical records database, converting the data, and outputting the converted data such that the unpopulated eCRF may be populated automatically on a regular basis.

17. Non-transitory, tangible computer readable medium as defined in claim 14, further comprising the step of designing an EMR, wherein the step of designing the EMR is performed by the interface design technician during the design and test phase of the method.

18. Non-transitory, tangible computer readable medium as defined in claim 17, wherein the step of designing an EMR includes designing an EMR to capture data unavailable data.
